(19) United States
(12) Patent Application Publication
(10) Pub. No.: US 2015/0228398 A1
(43) Pub. Date: Aug. 13, 2015

(54) TRANSFORMER

(71) Applicant: KABUSHIKI KAISHA TOYOTA JIDOSHOKKI, Aichi-ken (JP)

(72) Inventors: Sergey MOISEEV, Kariya-shi (JP); Yasuhiro KOIKE, Kariya-shi (JP); Tomohiro TSUJI, Kariya-shi (JP); Kenichi WATANABE, Kariya-shi (JP)

(73) Assignee: KABUSHIKI KAISHA TOYOTA JIDOSHOKKI, Aichi-ken (JP)

(21) Appl. No.: 14/613,715

(22) Filed: Feb. 4, 2015

(30) Foreign Application Priority Data
Feb. 7, 2014 (JP) 2014-022588

(51) Int. Cl. H01F 27/28

(52) U.S. Cl. CPC H01F 27/2823; H01F 27/2804; H01F 27/2876

(57) ABSTRACT

A transformer includes a first substrate, a second substrate, and an insulation sheet. A primary winding and a primary switching element are mounted on the first substrate. A secondary winding formed by a pattern of a metal plate is mounted on the second substrate. The second substrate overlaps the first substrate. The insulation sheet is arranged between the first substrate and the second substrate.

### BACKGROUND OF THE INVENTION

The present invention relates to a transformer.

An insulation-type DC-DC converter uses a transformer, which includes a primary winding and a secondary winding. Japanese Laid-Open Patent Publication No. 2013-150414 describes an example of a technique for integrating the primary winding and the secondary winding. The transformer described in the publication includes a primary coil substrate, a first secondary coil unit, and a second secondary coil unit. The primary coil substrate includes a primary coil that passes primary voltage. The first secondary coil unit is located closer to a baseplate than the primary coil substrate. The second secondary coil unit is located farther from the baseplate than the primary coil substrate. The second secondary coil unit sandwiches the primary coil substrate with the first secondary coil unit.

An insulation-type DC-DC converter uses a terminal or a connector as a connecting member that connects the winding (coil substrate) of the transformer and a switching element. The switching element regulates the current supplied to the winding of the transformer. In this case, the use of the terminal or connector as the connecting member increases the number of components. This may raise costs.

### SUMMARY OF THE INVENTION

It is an object of the present invention to provide a transformer configured to facilitate the coupling of windings and switching elements.

To achieve the above object, one aspect of the present invention is a transformer including a first substrate, a second substrate, and an insulation sheet. A primary winding and a primary switching element are mounted on the first substrate. A secondary winding formed by a pattern of a metal plate is mounted on the second substrate. The second substrate overlaps the first substrate. The insulation sheet is arranged between the first substrate and the second substrate.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a plan view showing a transformer according to one embodiment of the present invention in an insulation-type DC-DC converter;

FIG. 1B is a cross-sectional view taken along line 1B-1B in FIG. 1A;

FIG. 2 is a perspective view of the transformer shown in FIG. 1A;

FIG. 3 is a circuit diagram showing the electric configuration of the insulation-type DC-DC converter;

FIG. 4 is an exploded perspective view of the transformer shown in FIG. 2;

FIG. 5 is a perspective view of the transformer shown in FIG. 4;

FIG. 6 is a plan view of the transformer shown in FIG. 5;

FIG. 7 is a perspective view of the transformer shown in FIG. 4;

FIG. 8 is a plan view of the transformer shown in FIG. 7;

FIG. 9 is a perspective view of the transformer shown in FIG. 4;

FIG. 10 is a plan view of the transformer shown in FIG. 9;

FIG. 11 is a perspective view of the transformer shown in FIG. 4;

FIG. 12 is a plan view of the transformer shown in FIG. 11;

FIG. 13 is a perspective view of the transformer shown in FIG. 4;

FIG. 14 is a plan view of the transformer shown in FIG. 13;

FIG. 15 is a perspective view of the transformer shown in FIG. 4; and

FIG. 16 is a plan view of the transformer shown in FIG. 15.

### DETAILED DESCRIPTION OF THE PREFERRED EMBODIMENTS

One embodiment of an insulation-type DC-DC converter will now be described with reference to the drawings.

As shown in FIG. 3, an insulation-type DC-DC converter 10, which is a forward-type DC-DC converter, includes a transformer 11. The transformer 11 includes a primary winding 11a and a secondary winding 11b. The insulation-type DC-DC converter 10, which is used in automobiles, is installed in a vehicle. The insulation-type DC-DC converter 10, for example, lowers an input of 300 volts to an output of 12 volts.

One terminal of the primary winding 11a is connected to an input terminal, and the input terminal is connected to a positive terminal of a battery 12. A further terminal of the primary winding 11a is connected to ground via a primary switching element 14. A power MOSFET is used as the primary switching element 14.

The positive electrode of a smoothing capacitor 13 is connected between the input terminal and the primary winding 11a of the transformer 11. The negative electrode of the smoothing capacitor 13 is connected to ground. An electrolytic capacitor is used as the smoothing capacitor 13. The smoothing capacitor 13 smoothens the primary voltage of the transformer 11.

One terminal of the secondary winding 11b of the transformer 11 is connected to an output terminal via a series circuit of a diode 16 and a coil 18. In the diode 16, the anode is located at the side of the secondary winding 11b and the cathode is located at the output terminal side. A further terminal of the secondary winding 11b of the transformer 11 is connected to the output terminal. A capacitor 19 is connected between the coil 18 and the output terminal and between the further terminal of the secondary winding 11b of the transformer 11 and the output terminal. A diode 17 is arranged between the further terminal of the secondary winding 11b of the transformer 11 and the cathode of the diode 16. In the diode 17, the anode is located at the side of the secondary winding 11b and the cathode is located at the cathode side of the diode 16.

A control IC 15 is connected to the gate terminal of the primary switching element 14. A pulse signal is output from the control IC 15 to the gate terminal of the switching element 14. The pulse signal switches the primary switching element 14. When the primary switching element 14 is activated, the energy accumulated in the coil 18 is released to the output. In detail, DC voltage is supplied via the smoothing capacitor 13 to the primary winding 11a of the transformer 11. The control IC 15 controls the activation and deactivation of the primary switching element 14. When activated and deactivated, primary current flows to the primary winding 11a during the activated period of the primary switching element 14. Electromotive force at the transformer 11 generates a flow of secondary current. When the primary switching element 14 is deactivated, back electromotive force at the coil 18 causes the current of the coil 18 to flow to the output via the diode D17.

A detection circuit 20 is connected to the control IC 15, and the detection circuit 20 detects the output voltage Vout. The measurement result of the output voltage Vout is sent from the detection circuit 20 to the control IC 15. The control IC 15 uses the measurement result of the output voltage Vout from the detection circuit 20 as a feedback signal to duty-control the primary switching element 14 so that the output voltage Vout is regulated at a certain constant value.

The primary winding 11a, the smoothing capacitor 13, the primary switching element 14, the control IC 15, and the detection circuit 20 of the transformer 11 are mounted on the first substrate 21. Further, the secondary winding 11b, the diodes 16 and 17, the coil 18, and the capacitor 19 of the transformer 11 are mounted on the second substrate 22.

The specific structure of the transformer 11 will now be described.

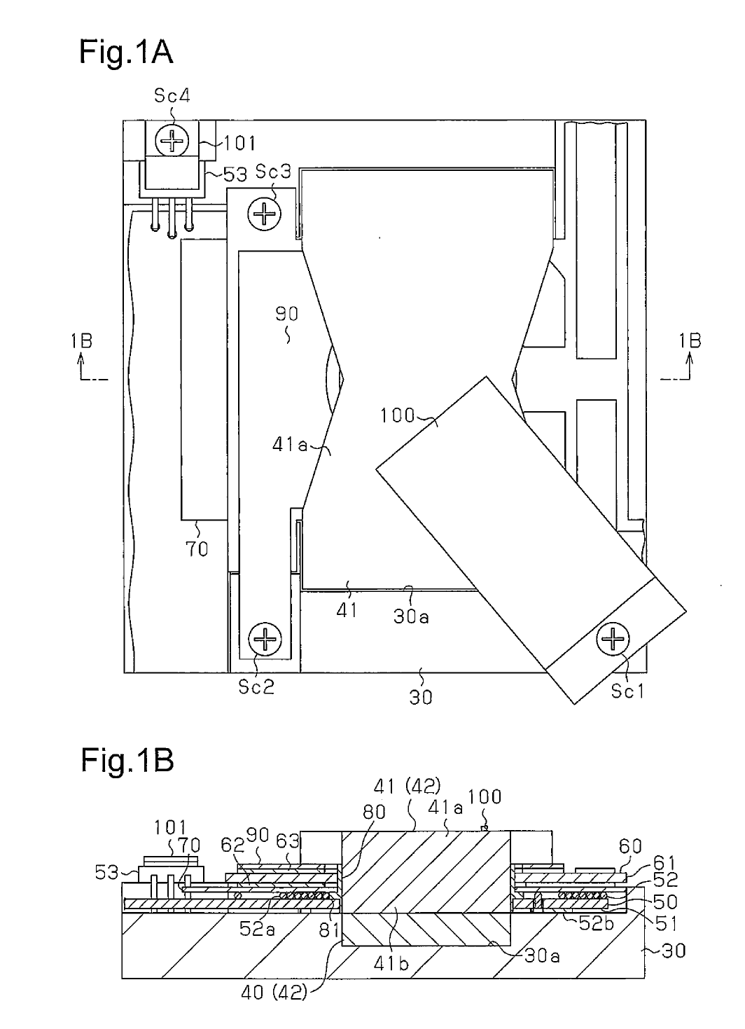

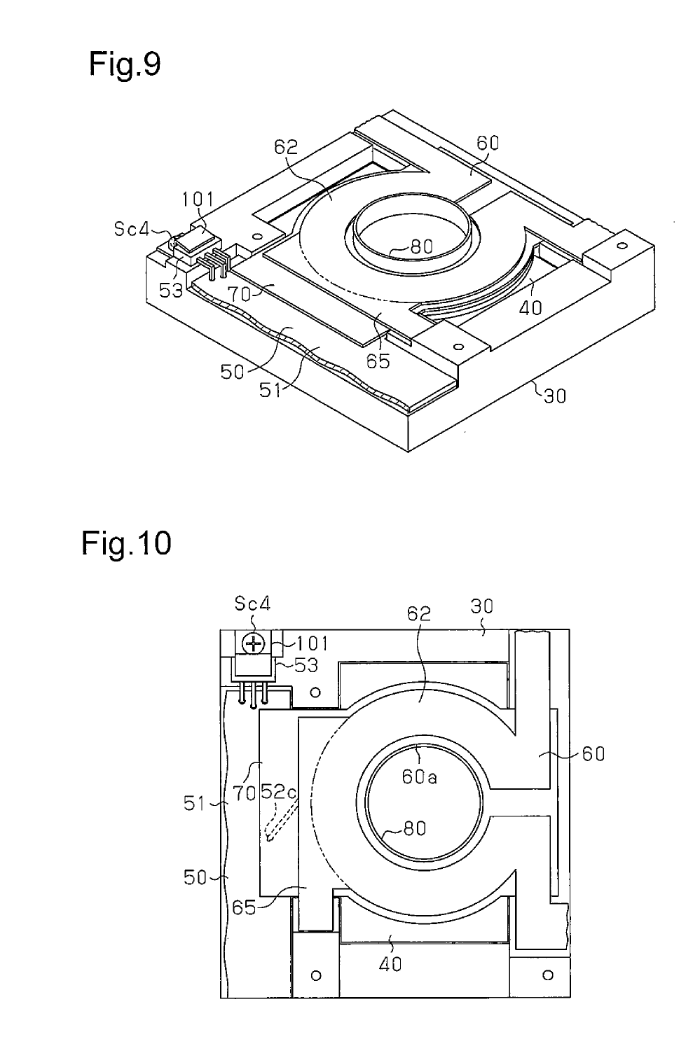

As shown in FIGS. 1A to 2 and 4, the transformer 11 includes a first substrate 50 (corresponding to first substrate 21 in FIG. 3), a second substrate 60 (corresponding to second substrate 22 in FIG. 3), and an insulation sheet 70, which is arranged between the first substrate 50 and the second substrate 60. The first substrate 50 and the second substrate 60 are arranged to overlap each other. A primary winding 52 (corresponding to primary winding 11a in FIG. 3) and a primary switching element 53 (corresponding to primary switching element 14 in FIG. 3) are mounted on the first substrate 50. As shown in FIGS. 9 and 10, a secondary winding 62 (corresponding to secondary winding 11b in FIG. 3), which is formed by the pattern of a metal plate (copper plate), is mounted on the second substrate 60.

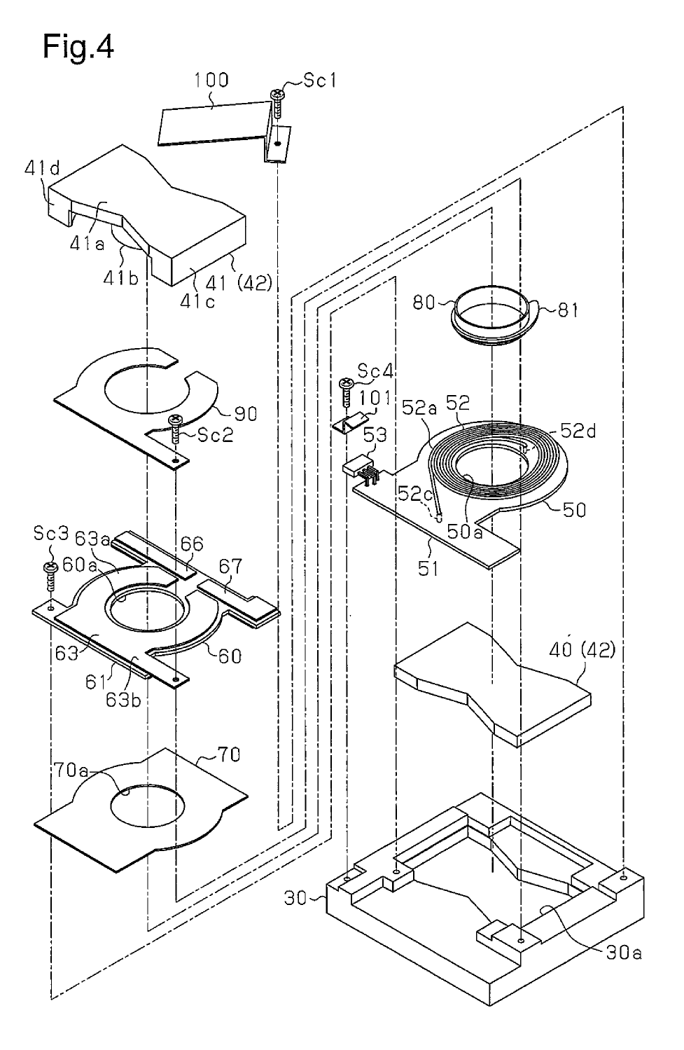

As shown in FIG. 10, the single-turn secondary winding 62 is patterned to be Q-shaped. A straight portion 65 is formed integrally with the secondary winding 62. The straight portion 65 extends straight in the tangential direction from the outer circumferential surface of an annular portion of the secondary winding 62. The primary winding 52 in FIG. 4 includes an extended wire 52c. As shown in FIG. 10, the primary winding 52 is connected to the first substrate 50 with the extended wire 52c separated from the contour of the secondary winding 62. Thus, the extended wire 52c does not overlap the secondary winding 62. Further, referring to FIG. 4, the extended wire 52c is embedded in the first substrate 50.

As shown in FIG. 4, the second substrate 60 includes a formation surface (lower surface), on which the metal plate pattern (62) is formed, and an opposite surface (upper surface), which is located at the opposite side of the formation surface. A metal plate 63, which is connected to an aluminum case 30 serving as a heat dissipation member, is arranged on the opposite surface. The metal plate 63 forms a heat dissipation route. The first substrate 50 includes a through hole 50a, and the second substrate 60 includes a through hole 60a. A core 42 is extended through the through holes 50a and 60a. The core 42 includes a lower core portion 40 and an upper core portion 41. An insulative tube 80 is fitted into the through holes 50a and 60a. The insulative tube 80 is formed by a plastic molded product. A flange 81 is formed integrally with the insulative tube 80. The flange 81 projects radially outward from the outer circumferential surface of the insulative tube 80. The flange 81 is located on the upper surface of the first substrate 50.

In the transformer, the primary winding 52 and the secondary winding 62 are mounted on separate substrates (50 and 60), and the substrates (50 and 60) are stacked upon each other when assembling the transformer. The primary winding 52 is mounted on an insulation substrate 51, which includes the primary switching element 53, or a primary power circuit, and the secondary winding 62 is adhered to, pressed against, and joined with an insulation substrate 61.

The lower core portion 40 has the form of a rectangular plate. The lower core portion 40 is an I-shaped core portion free from projections. The upper core portion 41, which has the form of a rectangular plate, includes a main body 41a extending in the horizontal direction, a central magnetic leg 41b projecting from a central section in one of the surfaces (lower surface) of the main body 41a, and two side magnetic legs 41c and 41d projecting from the ends of one of the surfaces (lower surface) of the main body 41a. The central magnetic leg 41b has the form of a round post, and the two side magnetic legs 41c and 41d each have the form of a polygonal post.

As shown in FIG. 4, a core fitting recess 30a is formed in an upper surface of the aluminum case 30. The lower core portion 40 is fitted to the core fitting recess 30a. As shown in FIGS. 1A, 1B, and 4, the upper core portion 41 is arranged on the lower core portion 40 so that the upper surface of the lower core portion 40 contacts the central magnetic leg 41b of the upper core portion 41. Further, the upper surface of the lower core portion 40 contacts the two side magnetic legs 41c and 41d of the upper core portion 41.

The insulative tube 80 is fitted to the central magnetic leg 41b of the upper core portion 41.

The first substrate 50 is arranged on the aluminum case 30. The insulation substrate 51 of the first substrate 50 includes a circular through hole 50a, and the insulative tube 80 is fitted in the through hole 50a.

In the first substrate 50, the primary switching element 53 includes leads extending through the insulation substrate 51 and soldered to the insulation substrate 51. A metal pressing plate 101 is arranged on the upper surface of the primary switching element 53, which is box-shaped. A screw Sc4, which extends through one end of the metal pressing plate 101, is fastened to the aluminum case 30. Thus, the other end of the metal pressing plate 101 presses the primary switching element 53 against the aluminum case 30 and supports the primary switching element 53 with the aluminum case 30.

As shown in FIGS. 4, 13, and 14, an upper winding portion 52a is arranged on the upper surface of the insulation substrate 51 of the first substrate 50. The upper winding portion 52a is formed by spirally winding a metal wire having a circular cross-section. A resin insulating material covers and insulates the surface of the wire. The upper winding portion 52a extends around the through hole 50a.

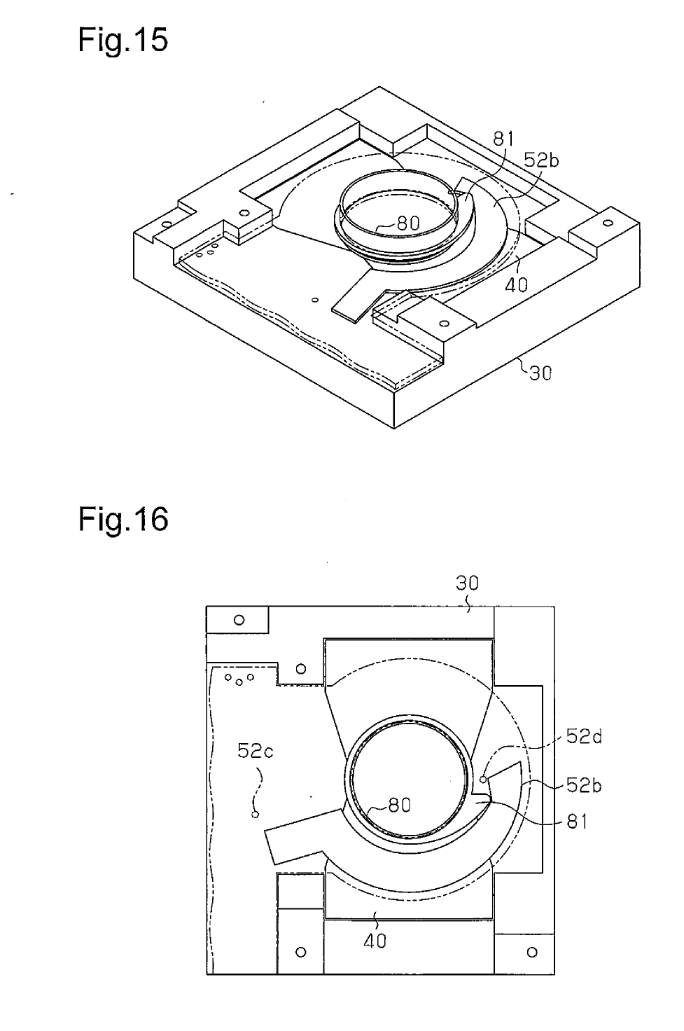

The two ends of the upper winding portion 52a are extended wires 52c and 52d. The extended wires 52c and 52d extend through the insulation substrate 51. A semi-arcuate conductor pattern 52b is formed on the lower surface of the insulation substrate 51 as shown in FIGS. 15 and 16. This forms a winding for one half of a turn. One end of the conductor pattern 52b and the extended wire 52d at one end of the upper winding portion 52a are soldered and electrically connected. The other end of the conductor pattern 52b defines an extended portion of a primary winding. This forms the primary winding 52 that has a predetermined number of turns.

A conductor pattern (not shown) formed on the insulation substrate 51 electrically connects the soldered primary switching element 53 and the primary winding 52. This eliminates the need for a connector or a connection terminal that connects the primary switching element 53 and the primary winding 52.

As shown in FIGS. 4, 11, and 12, the insulation sheet 70 is arranged on the first substrate 50. The insulation sheet 70 covers the upper winding portion 52a including the extended wire 52c of the primary winding 52 (refer to FIG. 14). The insulation sheet 70 includes a circular through hole 70a. The insulative tube 80 is fitted in the through hole 70a.

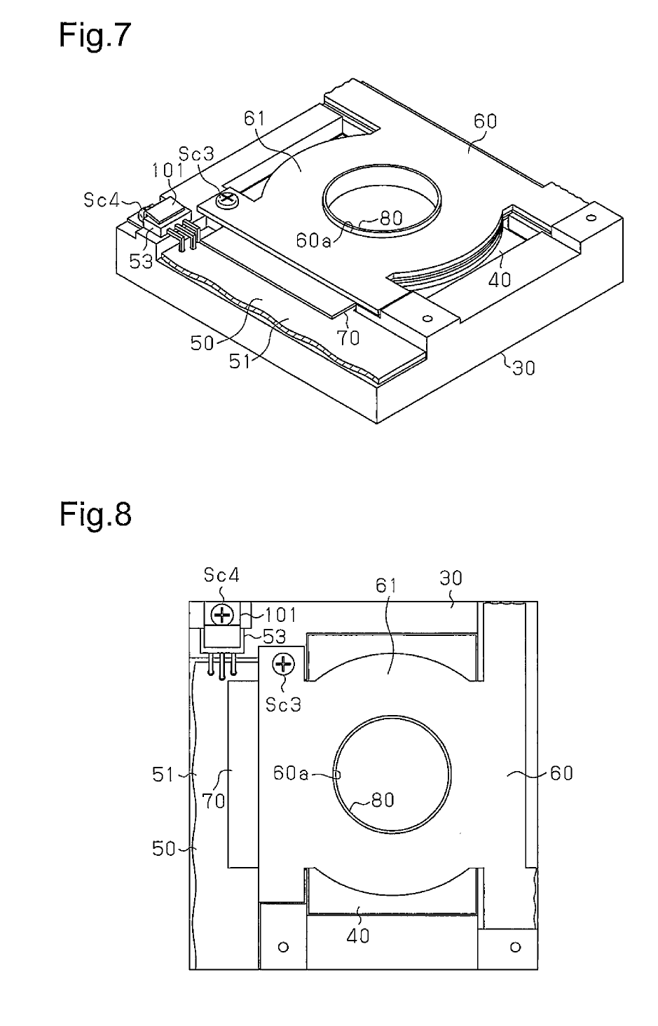

As shown in FIGS. 4, 5, and 6, the second substrate 60 is arranged on the insulation sheet 70. As shown in FIGS. 7 and 8, the insulation substrate 61 of the second substrate 60 includes a circular through hole 60a, and the insulative tube 80 is fitted to the through hole 60a.

The insulation substrate 61 of the second substrate 60 is supported by the aluminum case 30 by fastening a screw Sc3, which extends through the insulation substrate 61, to the aluminum case 30. Referring to FIGS. 9 and 10, the secondary winding 62 is coupled to the lower surface of the insulation substrate 61. The secondary winding is patterned to be Q-shaped and extends around the through hole 60a.

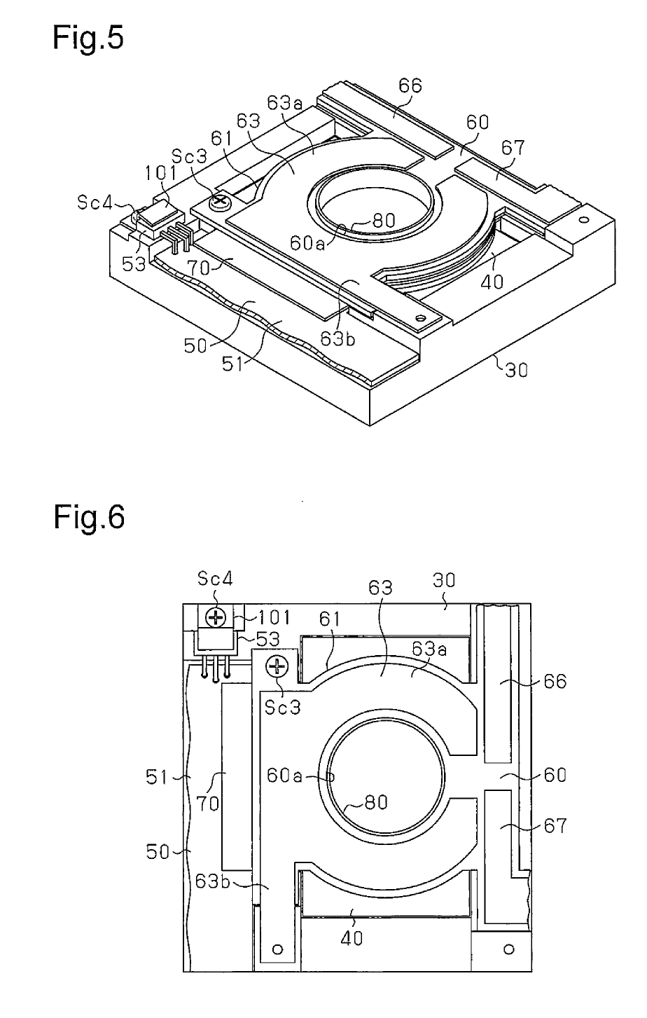

Referring to FIGS. 5 and 6, metal plates 63, 66, and 67 are coupled to the upper surface of the insulation substrate 61 in correspondence with the lower metal plates (62 and 65). If a metal plate (copper plate) were to be used only at the lower side of the insulation substrate 61 during pressing, the insulation substrate 61 would deform and adversely affect the adhesion properties. The metal plate 63 includes a portion 63a that corresponds to the annular portion of the secondary winding 62 and a portion 63b that corresponds to the straight portion 65. The metal plates 66 and 67 correspond to the straight portions of the secondary winding 62 and extend straight.

As shown in FIG. 4, an insulation sheet 90, which is shaped similar to the metal plate 63, is arranged on the second substrate 60. The insulation sheet 90 and the metal plate 63 are supported by the aluminum case 30 by fastening a screw Sc2, which extends through the insulation sheet 90 and the metal plate 63, to the aluminum case 30.

As shown in FIGS. 1A to 2 and 4, the upper core portion 41 is arranged on the insulation sheet 90. A metal pressing plate 100 is arranged on the upper surface of the upper core portion 41. The core portions 40 and 41 and the like are pressed against and supported by the aluminum case 30 by fastening a screw Sc1, which extends through one end of the metal pressing plate 100, to the aluminum case 30.

Sheets (not shown) used for insulation and heat dissipation are arranged between the aluminum case 30 and the lower core portion 40, between the aluminum case 30 and the first substrate 50, and between the aluminum case 30 and the metal plate 63.

The process for assembling the transformer will now be described.

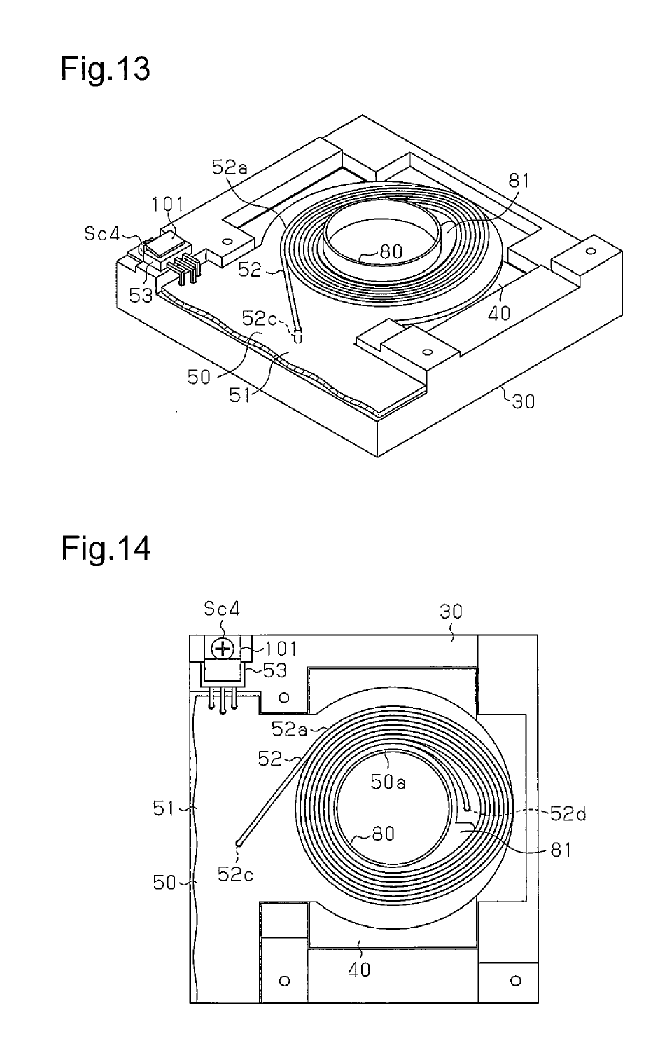

Referring to FIG. 4, the aluminum case 30 is prepared. The upper surface of the aluminum case 30 includes the core fitting recess 30a, into which the lower core portion 40 is fitted. Referring to FIGS. 13 and 14, the lower core portion 40 is fitted to the core fitting recess 30a of the aluminum case 30. Further, the first substrate 50 is arranged on the lower core portion 40, and the insulative tube 80 is fitted to the insulation hole of the first substrate 50.

The screw Sc4 is fastened to the aluminum case 30 to fix the primary switching element 53 to the aluminum case 30. The upper winding portion 52a, which is formed by spirally winding a metal wire having a circular cross-section, is arranged on the upper surface of the first substrate 50. The extended wires 52c and 52d at the two ends of the upper winding portion 52a extend through the insulation substrate 51.

The extended wires 52c and 52d at the two ends (wire) of the upper winding portion 52a are extended through the insulation substrate 51 and fixed to the insulation substrate 51. This prevents separation of the wire. The semicircular conductor pattern 52b is formed on the lower surface of the insulation substrate 51, and one end of the conductor pattern 52b is electrically connected to the extended wire 52d of the upper winding portion 52a. This forms the primary winding 52, which includes a predetermined number of turns. The primary switching element 53 is mounted on the first substrate 50. The primary switching element 53 and the primary winding 52 are electrically connected to a conductor pattern (not shown) formed on the insulation substrate 51.

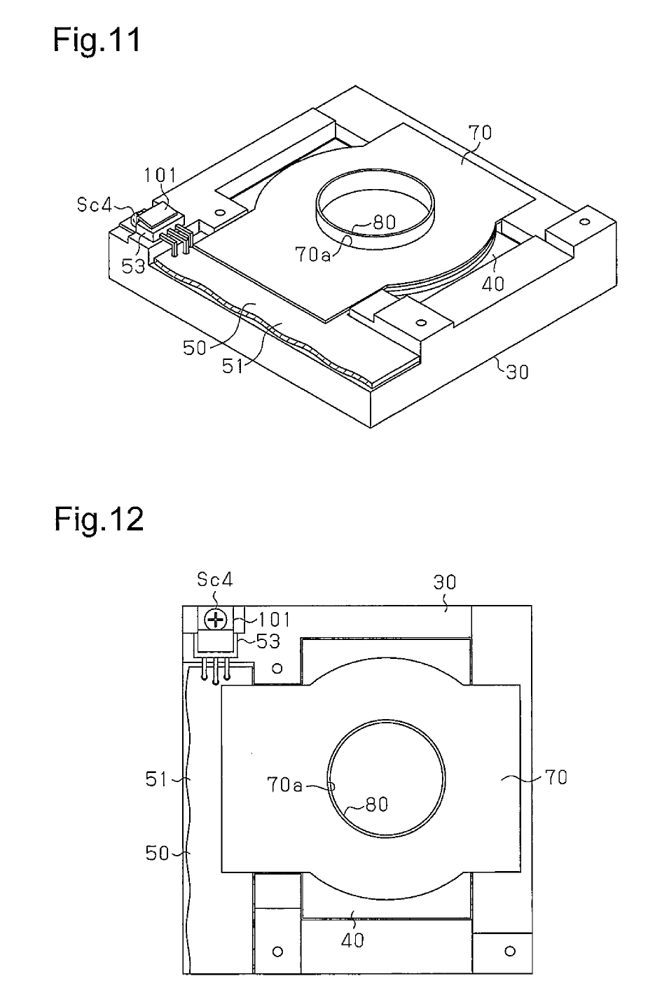

Then, referring to FIGS. 11 and 12, the insulation sheet 70 is fitted to the insulative tube 80 at the through hole 70a.

Referring to FIGS. 5 and 6, the second substrate 60 is fitted to the insulative tube 80 at the through hole 60a. The screw Sc3 is fastened to the aluminum case 30 to fix the second substrate 60 to the aluminum case 30. The secondary winding 62, or the patterned metal plate, on the second substrate 60 is coupled to the lower surface of the insulation substrate 61 shown in FIGS. 7 and 8. As shown in FIGS. 5 and 6, the metal plates 63, 66, and 67 are coupled to the upper surface of the insulation substrate 61.

In this manner, the two substrates 50 and 60 are stacked upon each other with the lower core portion 40 and the insulative tube 80 facilitating positioning. This facilitates the formation of the transformer. Further, the insulation sheet 70 insulates the first substrate 50 and the second substrate 60.

Then, the insulation sheet 90 is arranged on the second substrate, and the screw Sc2 is fastened to the aluminum case 30 to fix the insulation sheet 90 and the metal plate 63 of the second substrate 60 to the aluminum case 30. This thermally couples the metal plate 63 and the aluminum case 30.

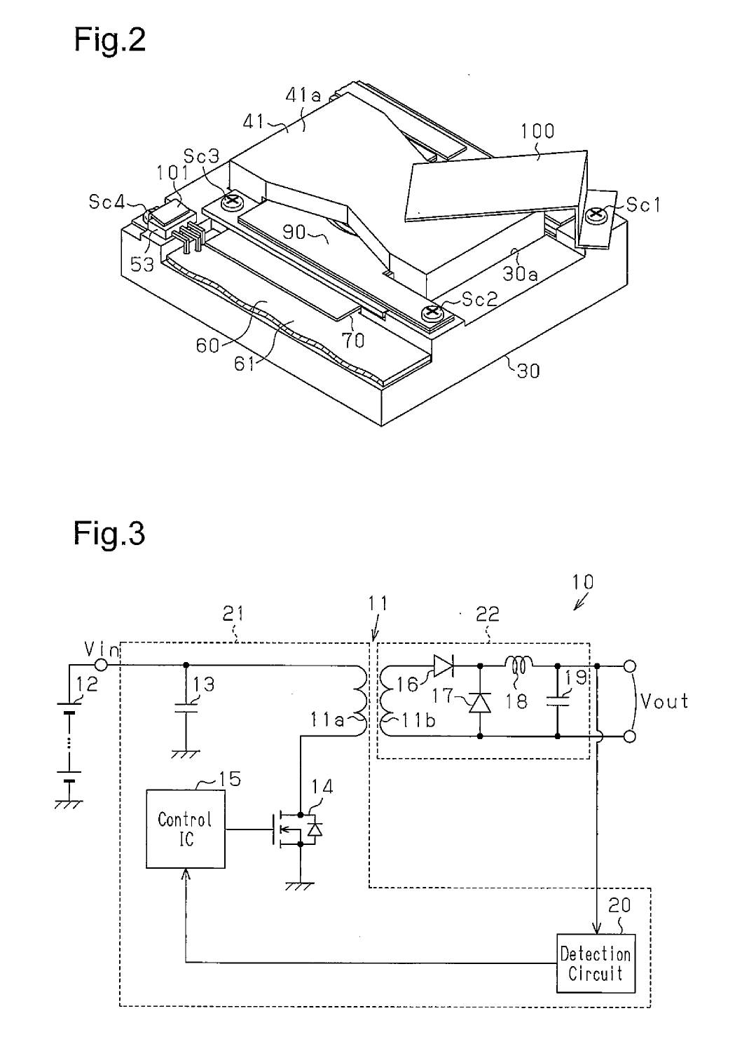

Subsequently, referring to FIGS. 1A to 2, the upper core portion 41 is arranged on the insulation sheet 90. Here, the central magnetic leg 41b of the upper core portion 41 is fitted to the insulative tube 80. Further, the metal pressing plate 100 is arranged on the upper core portion 41. The screw Sc1 is fastened to the aluminum case 30 to press and fix the core portions 40 and 41 with the metal pressing plate 100.

The transformer of an insulation-type DC-DC converter is formed in this manner.

The operation will now be described.

In FIGS. 1A to 2 and 4, when the primary switching element 53 undergoes a switching operation, current flows to the primary winding 52 and the secondary winding 62 of the transformer. This heats the primary winding 52 and the secondary winding 62. The primary switching element 53 corresponds to the primary switching element 14 of FIG. 3. The heat generated at the primary winding 52 is transmitted via the metal plate 63 of the second substrate 60 to the aluminum case 30 and released to the atmosphere from the aluminum case 30. The heat generated at the secondary winding 62 is transmitted via the metal plate 63 of the second substrate 60 to the aluminum case 30 and released to the atmosphere from the aluminum case 30. The metal plate 63 is insulated. Thus, when current flows to the secondary winding 62, eddy current does not flow to the metal plate 63.

Further, the insulative tube 80 is fitted to the through holes 50a and 60a of the substrates 50 and 60. The insulative tube 80 increases the distance along the surface of the insulation substrate 51 from the primary winding 52 to the core portions 40 and 41. This obtains the desired insulation distance.

In this manner, the primary winding 52 and the secondary winding 62 dissipates heat and has the desired insulation distance.

The above-described embodiment has the following advantages.

(1) The transformer 11 includes the first substrate 50, the second substrate 60, and the insulation sheet 70. The primary winding 52 and the primary switching element 53 are mounted on the first substrate 50. The second substrate 60 is arranged overlapping the first substrate 50. The insulation sheet 70 is arranged between the first substrate 50 and the second substrate 60. In this manner, the first substrate 50, on which the primary winding 52 and the primary switching element 53 are mounted, and the second substrate 60, on which the secondary winding 62 formed by the pattern of a metal plate is mounted, are stacked upon each other. Thus, the primary winding 52 and the primary switching element 53 are easily coupled to the transformer 11.

(2) The primary winding 52 is connected to the first substrate 50 with the extended wire 52c separated from the contour of the secondary winding 62. That is, the extended wire 52c does not overlap the secondary winding 62.

(3) The extended wire 52c of the primary winding 52 is embedded in the first substrate 50. This restricts separation of the primary winding 52 from the first substrate 50.

(4) The second substrate 60 includes the formation surface, on which the metal plate pattern (62) is formed, and the opposite surface, which is located on the opposite side of the formation surface. The metal plate 63, which is connected to the aluminum case 30, is arranged on the aluminum case 30. Thus, the transformer 11 has superior heat dissipation properties for releasing heat from the winding.

(5) The first substrate 50 and the second substrate 60 include the through holes 50a and 60a through which the core 42 extends. The insulative tube 80 is fitted to the through holes 50a and 60a. This obtains the desired insulation distance.

(6) The two substrates (50 and 60) are each independently fixed to the aluminum case 30. Further, the insulation sheet 70 absorbs vibration. This increases the durability of the transformer 11.

(7) The primary winding 52 is fixed. More specifically, the second substrate 60 and the like are arranged and fixed overlapping the first substrate 50. Thus, the primary winding 52, which is mounted on the first substrate 50, is pressed and fixed from above and below.

It should be apparent to those skilled in the art that the present invention may be embodied in many other specific forms without departing from the spirit or scope of the invention. Particularly, it should be understood that the present invention may be embodied in the following forms.

The shapes of the upper core portion 41 and the lower core portion 40 may be reversed. That is, the lower core portion 40 may include the central magnetic leg 41b and the two side magnetic legs 41c and 41d.

Instead of a power MOSFET, an IGBT or the like may be used as the primary switching element.

Instead of a DC-DC converter, the transformer may be applied to another device.

The present examples and embodiments are to be considered as illustrative and not restrictive, and the invention is not to be limited to the details given herein, but may be modified within the scope and equivalence of the appended claims.

1. A transformer comprising:
a first substrate on which a primary winding and a primary switching element are mounted;
a second substrate on which a secondary winding formed by a pattern of a metal plate is mounted, wherein the second substrate overlaps the first substrate; and
an insulation sheet arranged between the first substrate and the second substrate.

2. The transformer according to claim 1, wherein:
the primary winding includes an extended wire, and
the primary winding is connected to the first substrate with the extended wire separated from a contour of the secondary winding.

3. The transformer according to claim 1, wherein:
the primary winding includes an extended wire, and
the extended wire is embedded in the first substrate.

4. The transformer according to claim 1, wherein:
the second substrate includes a formation surface, on which the pattern of the metal plate is formed, and an opposite surface, which is located on an opposite side of the formation surface; and
the opposite surface includes a metal plate connected to a heat dissipation member.

5. The transformer according to claim 1, wherein:
the first substrate and the second substrate each include an insertion hole for insertion of a core, and
an insulative tube is fitted to the insertion hole.
